(19) United States
(12) Patent Application Publication
(10) Pub. No.: US 2021/0099282 A1
(43) Pub. Date: Apr. 1, 2021

(54) MANAGEMENT OF SOFTWARE DEFINED NETWORK CONFIGURATION DATA BASED ON HASH TREES

(71) Applicant: VMware, Inc., Palo Alto, CA (US)

(72) Inventors: Aayush Saxena, San Jose, CA (US); Aravinda Kidambi Srinivasan, Mountain View, CA (US); Pankaj Thakkar, Cupertino, CA (US)

(21) Appl. No.: 16/746,319

(22) Filed: Jan. 17, 2020

Related U.S. Application Data
(60) Provisional application No. 62/908,381, filed on Sep. 30, 2019.

(51) Int. Cl. H04L 9/06; G06F 16/23; G06F 16/901; G06F 16/907

(52) U.S. Cl. CPC H04L 9/0643; G06F 16/907; G06F 16/9027; G06F 16/23

(57) ABSTRACT

Described herein are systems and methods to manage and update software defined networking configurations on computing elements of a computing environment. In one example, a networking controller service may obtain hashes that correspond to a hash tree generated from software defined networking configuration data received by a computing element. The networking controller service may further compare the hashes to expected hashes for the computing element and determine that at least a portion of the software defined networking configuration data on the computing element requires an update based on the comparison. Once identified, the networking controller service may communicate the update to the computing element.

### RELATED APPLICATIONS

This application hereby claims the benefit of and priority to U.S. Provisional Patent Application No. 62/908,381, titled “MANAGEMENT OF SOFTWARE DEFINED NETWORK CONFIGURATION DATA BASED ON HASH TREES,” filed Sep. 30, 2019, and which is hereby incorporated by reference in its entirety.

### BACKGROUND

Software defined networks include logical entities that provide various networking operations for computing elements, such as virtual machines and containers. The networking operations may include routing operations, switching operations, firewall operations, or some other networking operations. To implement the networking operations, a networking controller may be required to distribute software defined networking configuration data to various computing elements that host the logical entities of the software defined networks. These computing elements may comprise host computing systems for virtual nodes, such as containers or virtual machines, may comprise routing or switching elements, or may comprise some other computing element.

As the software defined networks associated with an organization increase in size and computing resources, difficulties can arise in maintaining the networking configurations at each of the computing elements. These difficulties are often compounded when a communication link between the networking controller and a corresponding computing element fails for any number of reasons. These may include a failed physical connection between the networking controller the computing element, a software update for the computing element, a power outage, or for some other reason. The failed connection may cause inefficient quantities of data to be communicated between the controller and the computing element to determine any missed configuration updates, causing increased use of processing and networking resources to reconfigure the computing element.

### Overview

The technology disclosed herein enhances the management and deployment of software defined networking configurations in a computing environment. In one example, a networking controller for one or more software defined networks obtains hashes that correspond to a hash tree generated from software defined networking configuration data received by a computing element. The networking controller then compares the hashes to expected hashes and determines that at least a portion of the software defined networking configuration data on the computing element requires an update based on the comparison. Once the update is identified, the networking controller communicates the update for at least the portion of the software defined networking configuration to the computing element.

### BRIEF DESCRIPTION OF THE DRAWINGS

FIG. 1 illustrates an operational scenario of generating a hash tree from software defined networking configuration data according to an implementation

FIG. 2 illustrates a computing environment for software defined networking according to an implementation.

FIG. 3 illustrates an operation of a receiving computing element to update a local hash tree according to an implementation.

FIG. 4 illustrates an operation of a networking controller service to update a software defined networking configuration at a computing element according to an implementation.

FIG. 5 illustrates an operational scenario of maintaining a hash tree in a computing element according to an implementation.

FIGS. 6A-6B illustrate an operational scenario of updating a hash tree according to an implementation.

FIG. 7 illustrates a networking controller computing system according to an implementation.

FIG. 8 illustrates a computing system to implement logical elements according to an implementation.

### DETAILED DESCRIPTION

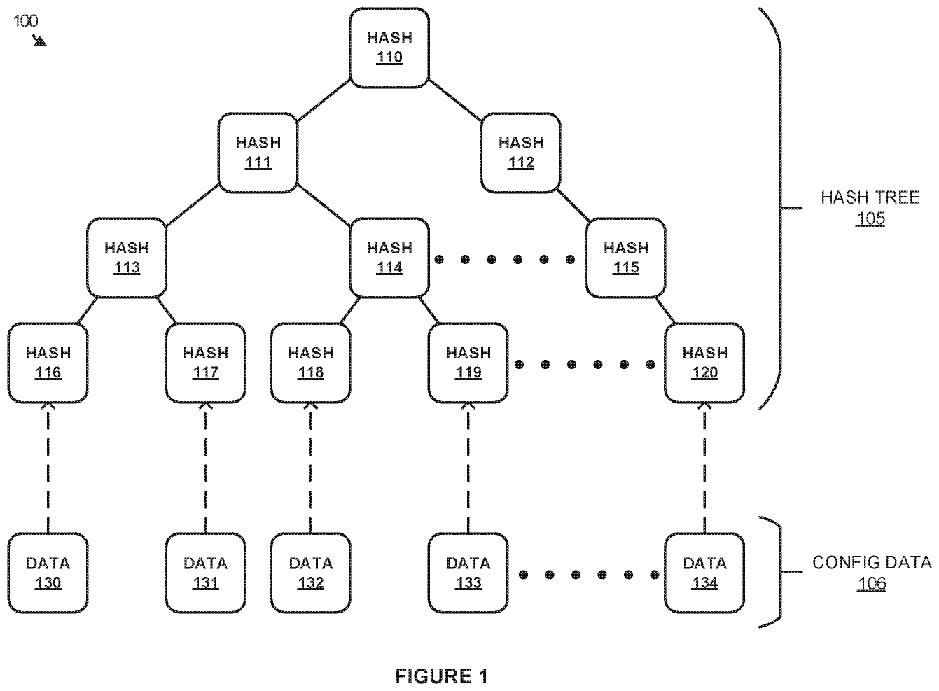

FIG. 1 illustrates an operational scenario 100 of generating a hash tree from software defined networking configuration data according to an implementation. Operational scenario 100 includes hash tree 105 and configuration data 106. Hash tree 105 includes hashes 110-120 and configuration data 106 includes data blocks 130-134 that are representative of configuration data for software defined networks.

In computing environments, organizations may deploy one or more software defined networks that can include logical routers, logical switches, firewalls, and other similar elements that can be used to provide networked communications between physical computing elements, virtual machines, containers, or other computing elements. To provide the required communications, a networking controller service may distribute required software defined networking configuration data to the various computing elements that support the one or more software defined networks. Here, the software defined networking configuration data is represented as configuration data 106 that is separated into data blocks represented as data 130-134. Configuration data 106 may represent firewall configurations, routing configurations, switching configurations, or other similar software defined networking configurations.

As configuration data is generated, the configuration data may be supplied to the various computing elements of the network, wherein each of the computing elements may receive one or more blocks from data 130-134. If a receiving computing element obtained all of the blocks that corresponds to configuration data 106, then the computing element may generate hash tree 105, wherein hash tree 105 may represent a Merkle tree in some examples. A hash tree is a tree in which each leaf node is labelled with the hash of a data block and every non-leaf node is labelled with the hash of the labels of its child nodes. Referring to an example of hash tree 105, hash 116 is a generated hash from data 130 and hash 117 is a generated hash from data 131. Hash 113 is a hash of both hashes 116-117. Similar processes may be repeated for the remaining hash nodes in hash tree 105. Although demonstrated with five leaf nodes, it should be understood that additional leaf nodes are included in hash tree 105 but have been omitted for clarity. Additionally, while demonstrated with four layers to the tree, it should be understood that any number of layers may be used in conjunction with the tree. Further, as configuration changes are made, blocks within the tree may be required to be split into additional blocks. For example, if configuration data were required to be added to data 130, the block for data 130 may be divided into two blocks. This division may add another layer to the hash tree.

After the generation of hash tree, various events may occur that may prevent the receiving computing element from updating configuration data 106 and hash tree 105. These events may include computing element updates, power outages, software changes, or some other event. As a result, when the computing element returns to operation from the communication interruption, the computing element may be required to update the locally maintained configuration data. In determining what configurations are required for an update, the computing element may provide hash tree 105 to the networking controller service, wherein the networking controller service may compare hash tree 105 to a current hash tree associated with a current version of the software defined networking configuration data. If hash tree 105 matches the current hash tree, then no updates are required to the configuration data. However, if hash tree 105 fails to match the current hash tree, then the networking controller service may be required to provide an update to at least a portion of the configuration data.

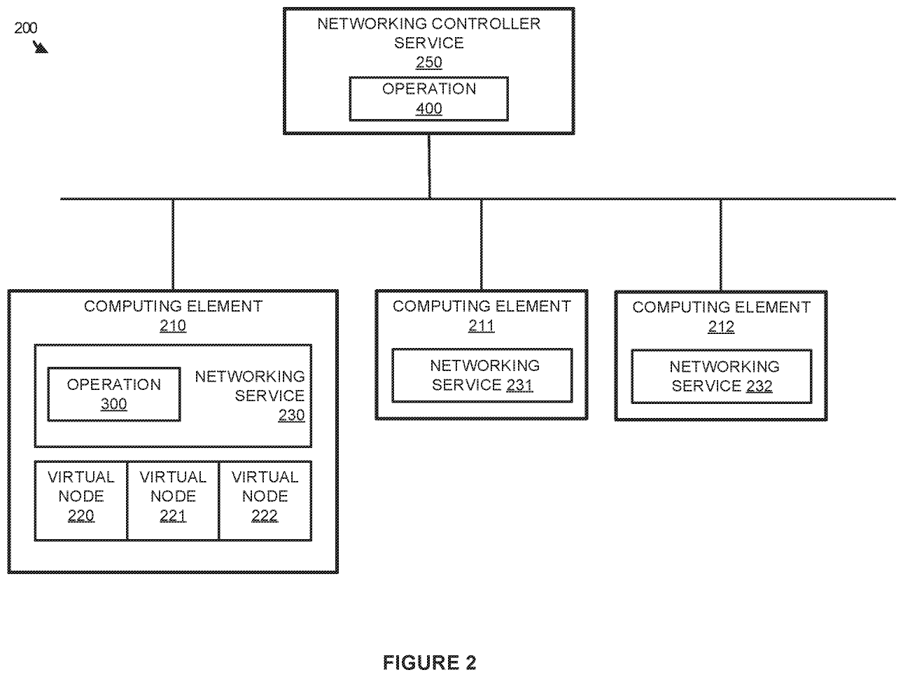

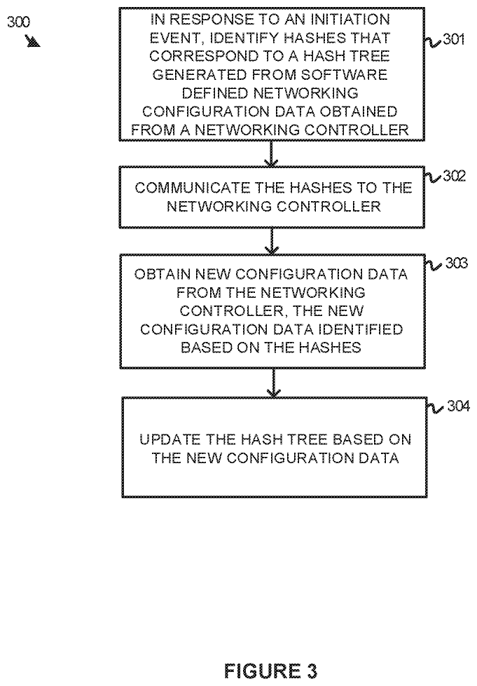

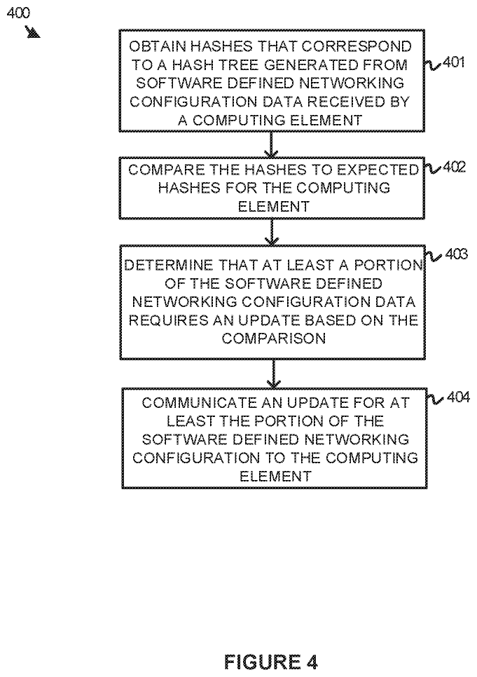

FIG. 2 illustrates a computing environment 200 for software defined networking according to an implementation. Computing environment 200 includes networking controller service 250 and receiving computing elements 210-212. Computing element 210 further includes networking service 230 with virtual nodes 220-222 and computing elements 211-212 further include networking services 231-232. Computing element 210 provides operation 300 that is further described below with respect FIG. 3 and networking controller service 250 provides operation 400 that is further described in FIG. 4.

In computing environment 200, computing elements 210-212 are deployed to provide a platform for one or more software defined networks. The software defined networks may be used to provide communications for virtual nodes (e.g., virtual machines, containers, and the like) or other computing elements, and may include logical switches, routers, firewalls, or some other software defined networking elements. To implement the one or more software defined networks, networking controller service 250 may provide software defined networking configuration data to each computing element of computing elements 210-212. In some implementations, the configuration data may be provided as data blocks, wherein the blocks are divided based on commonalities in the configuration data. The commonalities may include relations between logical entities, dependencies between logical entities, or some other information. For example, configuration data for a first logical switch may be included in a first block, while configuration data for a second logical switch may be included in a second block. In some implementations, all of the software defined networking configuration data is provided to each of the computing elements. In other implementations, a portion of the configuration data is provided to the computing elements based on the requirements of the computing elements. Thus, while a first computing element may implement a first logical switch for virtual nodes on the first computing element, the first computing element may not share configuration data with other computing elements that fail to implement operations associated with the first logical switch.

As the software defined networking configuration data is provided to each computing element of the computing elements, the computing elements may maintain a hash tree that can be used to define the state of the networking configuration at each of the computing elements. As an example, a networking configuration may be provided from networking controller service 250 as blocks. Computing element 210 may generate a leaf node associated with each of the blocks in the hash tree and build up the hash tree from the leaf nodes. When communication is interrupted between networking controller service 250 and computing element 210, computing element 210 may communicate the hashes in the hash tree to networking controller service 250 upon resuming the connection, permitting networking controller service 250 to determine the state of the configuration at computing element 210. If one or more blocks in the configuration at computing element 210 are determined to be different than the blocks of the current configuration maintained by networking controller service 250, then networking controller service 250 may provide updated blocks as part of the networking configuration to the computing element.

FIG. 3 illustrates an operation 300 of a receiving computing element to update a local hash tree according to an implementation. The processes of operation 300 are referenced parenthetically in the paragraphs that follow with reference to systems and elements of computing environment 200 of FIG. 2. Although demonstrated with respect to computing element 210, it should be understood that similar operations may be performed by computing elements 211-212.

As described herein, networking controller service 250 may maintain configuration data corresponding to one or more software defined networks implemented using computing elements 210-212. Networking controller service 250 may be responsible for distributing at least a portion of the configuration data to each computing element of computing elements 210-212 based on the requirements of the individual computing element. In particular, while computing element 210 may receive a first portion of the configuration data based on relevant logical entities to computing element 210, computing element 212 may receive a second, different portion of the configuration data based on relevant logical entities to computing element 212.

When the software defined networking configuration data is obtained by a computing element, such as computing element 210, computing element 210 may implement the required configuration and update or generate a hash tree based on the configuration data. In at least one implementation, the software defined networking configuration data may be provided in the form of blocks that can each include a quantity of data for the network or networks. As the blocks are obtained, computing element 210 may perform a hash on the blocks to generate the leaf nodes for the hash tree. Once the leaf nodes are generated, computing element 210 may generate the remaining nodes of the hash tree using the leaf nodes. After generating the original hash tree, networking controller service 250 may provide updated blocks to computing element 210, wherein computing element 210 may update the hash tree based on the updated or new blocks.

While maintaining the hash tree, the connection between networking controller service 250 and computing element 210 may be interrupted as a result of a software update to computing element 210, a power outage associated with computing element 210, or some other reason. After the interruption, computing element 210 may, in response to an initiation event or a reestablished connection with the networking controller service, identify (301) hashes that correspond to a hash tree generated from software defined networking configuration data obtained from the networking controller service. Once the hashes are identified from the hash tree, computing element 210 may further communicate (302) the hashes to the networking controller service. This communication may permit networking controller service to compare the hashes of the configuration version on computing element 210 to a current configuration version for the software defined network.

When it is determined that the configurations differ between the current configuration and the configuration local to computing element 210, computing element 210 may obtain (303) new configuration data from the networking controller, the new configuration data identified based on the hashes provided to the networking controller service. As an example, when the hashes are provided from computing element 210 to networking controller service 250, networking controller service may determine that a leaf node of the expected tree (generated from the current configuration) differs from a leaf node provided by computing element 210. Networking controller service 250 may then determine a configuration data block to provide to computing element 210 that corresponds to the leaf node in the expected tree and provides the data block to the computing element.

Once the new configuration data is obtained, computing element 210 updates (304) the hash tree based on the new configuration data and may update the software defined networking configuration based on the new configuration data. In at least one example, the new configuration data may comprise one or more blocks that can be used to replace older blocks or add new blocks to the configuration. Computing element 210 and networking service 230 may generate a hash for each of the one or more new blocks and update the hash tree using the newly generated hashes.

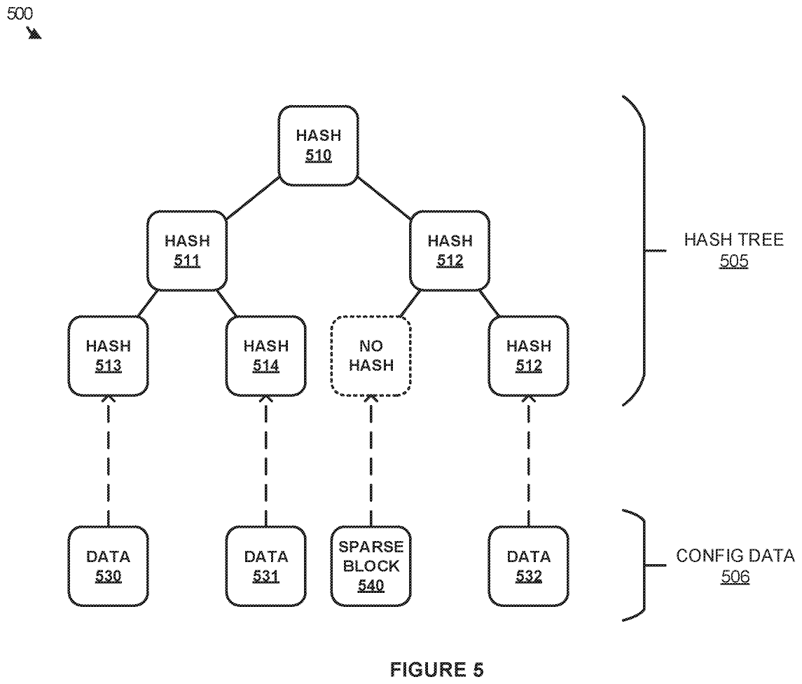

In some implementations, the software defined networking configuration data that is provided computing elements 210-212 may be uniquely identified for the specific computing element. For example, while an overall software defined networking configuration for the entire computing environment may include sixteen leaf nodes generated from sixteen data blocks, a computing element may only require configuration data corresponding to four of the sixteen leaf nodes. Instead of providing the computing element with all of the configuration data, networking controller service 250 may provide only the required data blocks and provide sparse blocks in place of the remaining blocks. Additionally, when generating the hash tree, the sparse blocks may be ignored (i.e., not used to generate leaf nodes) and the leaf nodes for the actual data blocks may be used to generate the sparse tree (see example in FIG. 5).

In some implementations, the data blocks that are provided by the networking controller service may group networking configuration data based on dependencies in the network topology. For example, data for a logical port configuration may be placed in the same block as the data for the logical switch on which it resides. Advantageously, configuration data that is likely commonly required by a computing element may be grouped in the same data block, limiting the quantity of blocks required by the computing element and/or providing efficiency in the transmission of data to the computing element.

In some examples, networking controller service 250 may use a network topology dependency graph, which is described in U.S. Pat. No. 10,397,055 and is incorporated by reference herein. In particular, networking controller service 250 may identify dependencies in the dependency graph, identify configuration information for an element and its dependencies, and hash the configuration information for an element with the configuration information for its dependencies. In the example, of a virtual switch, the hashed configuration information may include the configuration for a switch along with the configuration information for any ports on the switch.

FIG. 4 illustrates an operation 400 of a networking controller service to update a software defined networking configuration at a computing element according to an implementation. The processes of operation 400 are referenced parenthetically in the paragraphs that follow with reference to systems and elements of computing environment 200 of FIG. 2. Although demonstrated as separate from the computing elements hosting the logical elements of the computing environment, it should be understood that operation 400 may be implemented on one of computing elements 210-212.

In operation, networking controller service 250, in response to reestablishing a connection with a computing element, obtains (401) hashes that correspond to a hash tree generated from software defined networking configuration data received by the computing element during at least one previous connection with the networking controller service. In some implementations, networking controller service 250 may maintain configuration data for one or more software defined networks and distribute the configuration data to computing elements that provide a platform for the logical entities included in the one or more software defined networks. In some implementations, the configuration data may be provided as data blocks, wherein the computing elements may generate hashes for the various data blocks to generate a hash tree.

When a computing element returns from a connection interruption with networking controller service 250, the computing element may be required to determine whether any configuration modifications have been issued for the software defined networking configuration during the downtime of the connection. As a result, the computing element may communicate hashes from the local hash tree to networking controller service 250. As an example, computing element 210 may generate a hash tree based on configuration data blocks obtained during one or more prior connections with networking controller service 250. When a new connection is established following an interruption to a previous connection, computing element 210 may communicate the locally maintained hash tree to networking controller service 250.

In response to obtaining the hashes from the computing element, operation 400 may further compare (402) the hashes to expected hashes for the computing element, wherein the expected hashes may be generated from a current version of the software defined networking configuration. In particular, while the computing element may maintain a first version of the software defined networking configuration, the first version may differ from the current version as a result of updates during the downtime of the connection with networking controller service 250. As a result, the hashes for the first version and current version may be compared to identify whether any configuration changes have occurred since the downtime of the computing element. In some implementations, networking controller service 250 may generate the hash tree only when a connection is reestablished with a computing element. For example, when a connection is reestablished with computing element 210, networking controller service 250 may generate a hash tree that corresponds to the current configuration for computing element 210. In other implementations, networking controller service 250 may locally maintain hash trees for each computing element in the computing environment.

In the example of operation 400, networking controller service 250 determines (403) that at least a portion of the software defined networking configuration at the computing element requires an update based on the comparison. In some implementations, networking controller service 250 may compare the hash corresponding to the root of the hash tree maintained at the computing element to the root of a hash tree determined from a current configuration of the one or more software defined networks. If the root node hashes do match, then networking controller service 250 may determine that configuration changes are not required for the computing element. In contrast, if the root node hashes do not match, networking controller service 250 may process and compare the remaining hashes in the hash trees to determine what configuration data blocks have been changed (i.e., the portion of the software defined networking configuration that requires the update).

Once it is determined that at least a portion of the software defined networking configuration requires an update, networking controller service 250 may communicate (404) an update for at least the portion of the software defined networking configuration to the corresponding computing element. In some implementations, when comparing the hashes, networking controller service 250 may identify one or blocks in a plurality of blocks for the computing element that require an update. As a result, only the one or more blocks that have been updated, or are new to the configuration, are provided to the computing element rather than the entire configuration.

In some implementations, the overall software defined networking configuration maintained by networking controller service 250 may be divided into blocks of data that can be separated and provided to computing entities as required. For example, while computing element 210 may require first blocks from the complete configuration, computing element 212 may require second blocks from the complete configuration. Instead of providing each of the computing elements with the entire configuration, networking controller service 250 may only provide blocks that include the configuration data relevant to the particular computing element, while any irrelevant blocks may be provided as a sparse block. When this configuration is obtained by a computing element the hash tree may be generated using only the relevant blocks to generate the leaf nodes and propagating the leaf nodes up the tree to generate the hash tree for that particular computing element. An example of this is demonstrated in FIG. 5.

In some examples, as the overall software defined network configuration is divided into blocks, networking controller service 250 may provide optimizations to the blocks. These optimizations may include what data is stored in each of the blocks, the size of the blocks, or some other optimization. In at least one implementation, networking controller service 250 may determine block use information data by monitoring what configuration data and/or blocks are required for use by each computing element. This information may include the average quantity of blocks used by each of the computing elements, statistics about what computing elements share the same data and/or blocks, statistics about the quantity of data in each block used by each of the computing elements, or some other block use information. The information may then be compared to criteria or thresholds that may be used to change the sizes of the blocks, to rearrange blocks, to change what data is stored on one or more of the blocks, or to provide some other operation. For example, statistics may indicate that computing elements 210-212 frequently only use a small portion of the data blocks provided. As a result, networking controller service 250 may decrease the size of the data blocks to ensure that only relevant data is provided to the computing elements. In other examples, networking controller service 250 may reorganize the ordering of the configuration blocks, may change the data that is stored in each of the blocks, or provide some other operation that can limit the size of the hash trees and/or the quantity of blocks provided to each of the computing elements.

FIG. 5 illustrates an operational scenario 500 of maintaining a hash tree in a computing element according to an implementation. Operational scenario 500 includes hash tree 505 and configuration data 506 that is representative of software defined network configuration data. Hash tree 505 includes hashes 510-514 and configuration data 506 includes data 530-532 and sparse block 540.

As described herein, a networking controller service may provide software defined networking configuration data as blocks to computing elements in a computing environment. In some implementations, the blocks that are relevant to each computing element may be unique to the computing element. For example, a first set of blocks may be identified as relevant for first computing element and a second set of blocks may be identified as relevant for a second computing element. There may be at least a portion of the blocks that are relevant to both the first computing element and the second computing element in some examples. Rather than providing the full configuration for the software defined networks to each of the computing elements, the networking controller service may determine the blocks that are relevant for the operations at each of the computing elements. This may include identifying the logical entities and networking dependencies that are operating on each of the computing elements and identifying the configuration data blocks that include data relevant to the logical entities and networking dependencies. Once the relevant blocks are identified, the blocks may be provided to the corresponding computing element. Additionally, any of the blocks that are not relevant to the computing element may be provided as a sparse data block, which indicates that the block is empty and/or not required for the computing element.

Here, blocks for data 530-532 are identified as relevant to a computing element, while sparse block 540 is identified as irrelevant for the computing element. Once provided to the computing element as configuration data 506, the computing element may generate hash tree 505 based on the blocks. In particular, data 530-532 may be used to generate hashes 512-514, while sparse block 540 is not used to generate a hash for the tree. Instead, while hashes 513-514 are used to generate a parent node 511, hash 512 is promoted as its own parent node. Hashes 511-512 are then used to generate the root node 510. Advantageously, by providing the sparse blocks, the computing element may reduce the amount of storage required for the configuration data associated with the software defined network(s) and reduce the amount of data required to be transferred as part of the hash tree to determine whether an update is required by the computing element.

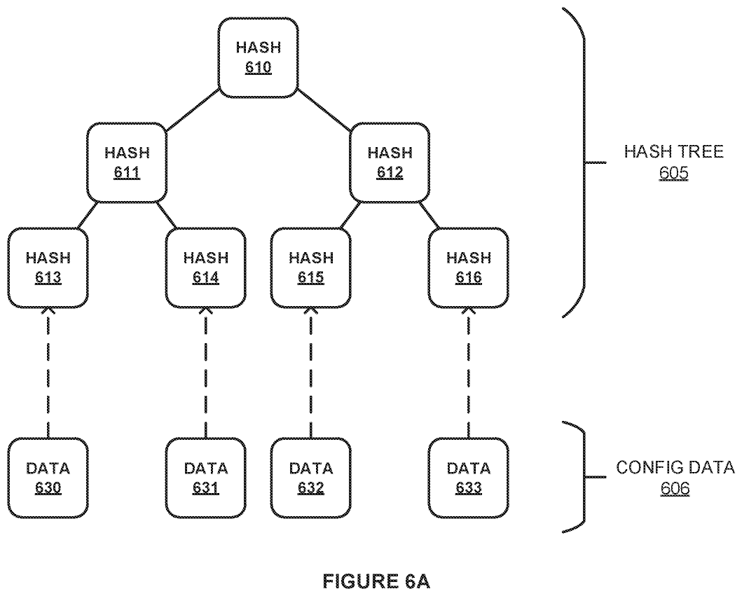

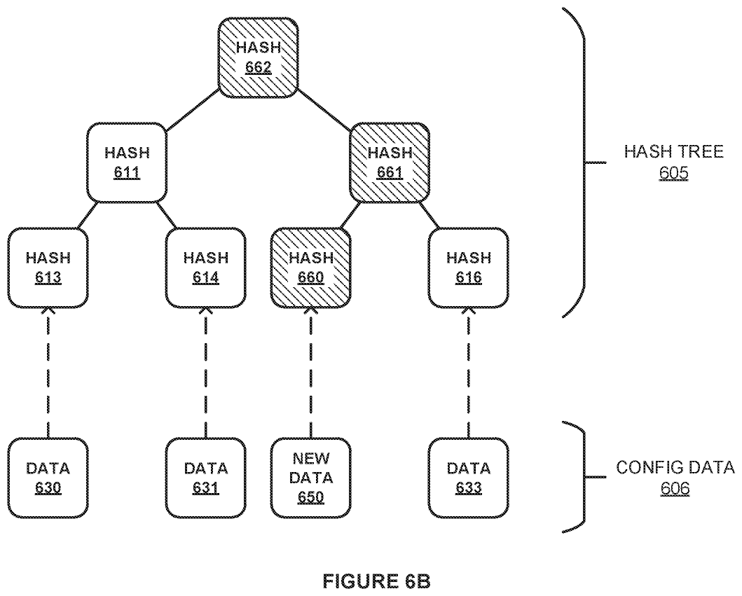

FIGS. 6A-6B illustrate an operational scenario of updating a hash tree according to an implementation. FIGS. 6A-6B include has tree 605 and configuration data 606 that is representative of software defined networking data that is provided to computing element that provides a platform for one or more logical entities in a software defined network. FIG. 6A includes hashes 610-616, while FIG. 6B replaces hashes 610, 612, and 615 with hashes 660-662.

Referring first to FIG. 6A, configuration data 606 includes blocks of data 630-633, wherein the blocks are provided by a networking controller service for a software defined network. As the blocks are obtained, the configuration data in the blocks may be used to configure various logical elements hosted by the computing element, including logical routers, logical switches, firewalls, or some other logical elements. Additionally, the blocks may be used to generate hash tree 605, where data 630-633 is used to generate corresponding hashes 613-616. These hashes may comprise 16-bit hashes, 64-bit hashes, 128-bit hashes, or some other hash derived from the data in data 630-633. Once hashes 613-616 are generated, the computing element may complete hash tree 605 using the information from hashes 613-616. In particular, the information from hashes 613-614 may be used to generate hash 611, the information from hashes 615-616 may be used to generate hash 612, and the information from hashes 611-612 may be used to generate hash 610.

When the computing element returns from a communication interruption with a networking controller, the computing element may provide hash tree 605 to the networking controller to determine whether any information should be updated in the software defined networking configuration maintained at the computing element. In some implementations, the networking controller may compare hash tree 605 that is provided to an expected hash tree for the computing element. If the hash trees do not match, then the networking controller may determine configuration modifications, or blocks of data, that are required to be transferred to the computing element. In contrast if the trees to match, then the networking controller may determine that the configuration is correct and requires no changes to be provided to the computing element.

Turning to FIG. 6B, after a connection is reestablished with the networking controller, the networking controller provides new data 650 that is used to replace data 632. Once new data 650 is obtained, the networking computing system may implement an update to hash tree 605 to reflect the newly replaced data. In this example, because new data 650 is added, hashes 610, 612, and 615 are replaced with hashes 660-662. Once hash tree 605 is updated and the software defined networking configuration is updated based on new data 650, the update operation is completed.

Although demonstrated in the example of FIGS. 6A-6B as replacing an existing data block, it should be understood that configuration data may be added to a software defined configuration. In particular, while 630-633 may remain in place, additional blocks may be provided as part of an update to reflect changes in the network configuration. As a result, hash tree 605 may expand due to an increased quantity of blocks provided to the computing element. In some implementations, rather than providing an entire software defined networking configuration to a computing element, the networking controller may only provide blocks that are relevant to the particular computing element. These relevant blocks may be identified based on logical entities hosted by the computing element as well as dependencies on other logical elements located on other computing elements. The relevant blocks provided to the computing element may then be used to generate the hash tree and configure the logical elements located on the computing element. In some examples, while configuration data is provided as part of the relevant blocks to the corresponding computing element, blocks that are not relevant to the computing element may be provided as sparse blocks to conserve data transfer and local storage of the entity. These sparse blocks may then be skipped in the generation of the hash tree similar to the operations depicted with respect to FIG. 5.

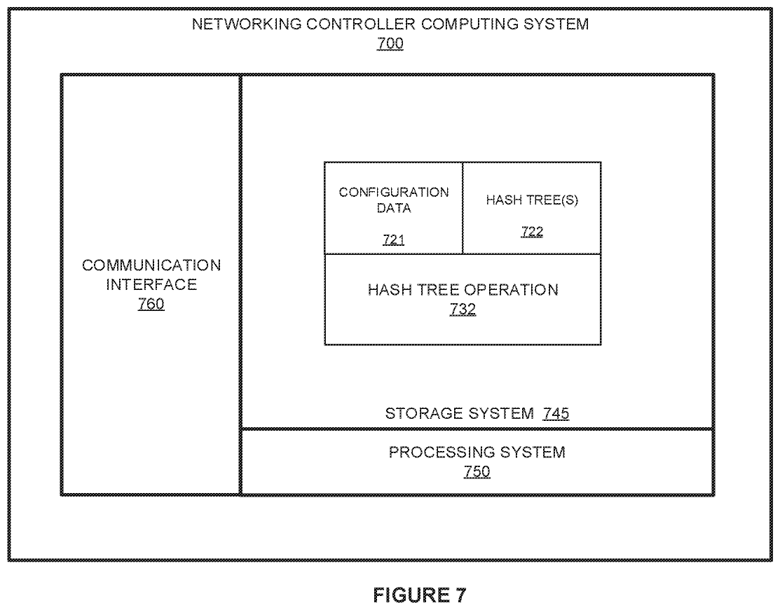

FIG. 7 illustrates a networking controller computing system 700 according to an implementation. Computing system 700 is representative of any computing system or systems with which the various operational architectures, processes, scenarios, and sequences disclosed herein for a networking controller service can be implemented. Computing system 700 is an example of networking controller service 250, although other examples may exist. Computing system 700 includes storage system 745, processing system 750, and communication interface 760. Processing system 750 is operatively linked to communication interface 760 and storage system 745. Communication interface 760 may be communicatively linked to storage system 745 in some implementations. Computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format—including combinations thereof. Communication interface 760 is an example of a physical network interface that can be configured to communicate with other computing systems to provide required operations for the processes executing on computing system 700.

Processing system 750 comprises microprocessor and other circuitry that retrieves and executes operating software from storage system 745. Storage system 745 may include volatile and nonvolatile, removable and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 comprises configuration data 721, hash tree(s) 722, and hash tree operation 732. The operating software on storage system 745 may further include utilities, drivers, network interfaces, applications, or some other type of software. When read and executed by processing system 750 the operating software on storage system 745 directs computing system 700 to operate as described herein.

In at least one implementation, hash tree operation 732 may direct processing system 750 to provide software defined networking information, represented as configuration data 721, to computing elements that host logical entities associated with one or more software defined networks. In addition to providing configuration data 721, hash tree operation 732 further maintains hash tree(s) 722 that are associated with configuration data 721, wherein configuration data 721 is divided into blocks and each of the blocks is used to generate a leaf node for a hash tree. The hash tree is then complete upward from the leaf nodes. When a connection is failed between a computing element and computing system 700 and the connection is reestablished, the computing element may provide a local hash tree that corresponds to software defined networking configuration information that was provided to the computing element. Once received, hash tree operation 732 may compare the received tree rom the computing element to a locally maintained tree, which corresponds to the current configuration of the software defined network. If the tree matches, then no updates are required to be provided to the computing element. If the tree fails to match the expected tree, then computing system 700 may identify relevant updates based on the differences between the trees, and provide the updates, as blocks, to the computing entity.

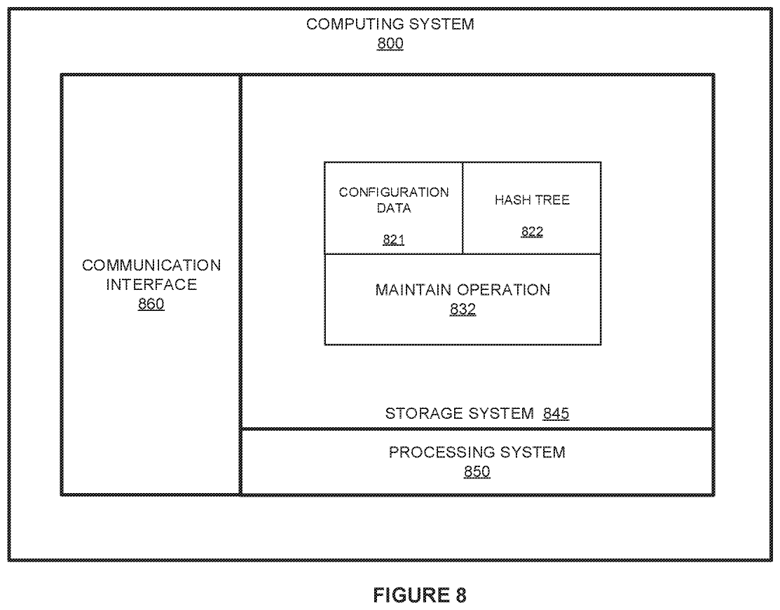

FIG. 8 illustrates a computing system 800 to implement logical elements according to an implementation. Computing system 800 is representative of any computing system or systems with which the various operational architectures, processes, scenarios, and sequences disclosed herein for a computing element can be implemented. Computing system 800 includes storage system 845, processing system 850, and communication interface 860. Processing system 850 is operatively linked to communication interface 860 and storage system 845. Communication interface 860 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency (RF), processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format—including combinations thereof. Communication interface 860 is an example of a physical network interface that can be configured to communicate with other computing systems to provide required operations for the processes executing on computing system 800. In at least one example, communication interface 860 may communicate with at least a networking controller system, such as networking controller computing system 700 of FIG. 7.

Processing system 850 comprises microprocessor and other circuitry that retrieves and executes operating software from storage system 845. Storage system 845 may include volatile and nonvolatile, removable and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 850 is typically mounted on a circuit board that may also hold the storage system. The operating software of storage system 845 comprises computer programs, firmware, or some other form of machine-readable program instructions. The operating software of storage system 845 comprises configuration data 821, hash tree 822, and maintain operation 832. The operating software on storage system 845 may further include utilities, drivers, network interfaces, applications, or some other type of software. When read and executed by processing system 850 the operating software on storage system 845 directs computing system 800 to operate as described herein.

In at least one implementation, maintain operation 832 directs processing system 850 to obtain software defined networking configuration data, represented as configuration data 821, from a networking controller service. As the configuration data is obtained, maintain operation 832 may maintain hash tree 822 that corresponds to configuration data 821 and may further use the configuration data to configure logical elements provided by computing system 800. In particular, the configuration data may be provided as data blocks. The blocks may be used to generate leaves for hash tree 822. From the leaves or the lowest level of the tree, maintain operation 832 may generate the rest of hash tree 822.

As hash tree 822 is maintained, an interruption may be identified for the communications between the networking controller service and computing system 800. Once the communication is reestablished or an initiation event is identified, maintain operation 832 may communicate hash tree 822 to the networking controller service, wherein the networking controller service may use the hash tree to determine whether any updated blocks should be provided to computing system 800. If a block in configuration data 821 is to be replaced or added, the networking controller service may provide the new block. Once provided, maintain operation 832 may update the logical element configurations and update hash tree 822 with the corresponding block.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method of operating a networking controller service comprising:
in response to reestablishing a connection with a computing element, obtaining hashes that correspond to a hash tree generated from software defined networking configuration data received by the computing element during at least one previous connection with the networking controller service;
comparing the hashes to expected hashes for the computing element;
determining that at least a portion of the software defined networking configuration data on the computing element requires an update based on the comparison; and
communicating the update for at least the portion of the software defined networking configuration to the computing element.

2. The method of claim 1, wherein the hash tree comprises a Merkle tree.

3. The method of claim 1 further comprising generating the expected hashes for the computing element using a current version of the software defined networking configuration data.

4. The method of claim 1, wherein the software defined networking configuration data comprises a plurality of blocks, and wherein the portion of the software defined networking configuration comprises one or more blocks in the plurality of blocks.

5. The method of claim 4, wherein a lowest level of the hash tree comprises a plurality of hashes generated from the plurality of blocks.

6. The method of claim 4, wherein each block in the plurality of blocks comprises configuration data entries corresponding to logical networking elements, and wherein configuration data entries for dependent logical networking elements are grouped together in one or more common blocks of the plurality of blocks.

7. The method of claim 1, wherein the software defined networking configuration data comprises a plurality of blocks, wherein a first subset of the plurality of blocks correspond to data to configure logical networking elements for one or more software defined networks, and wherein a second subset of the plurality of blocks correspond to sparse blocks of data.

8. The method of claim 7 further comprising:
identifying the first subset of the plurality of blocks based on logical networking elements on the computing element.

9. The method of claim 7, wherein communicating the update for at least the portion of the software defined networking configuration to the computing element comprises communicating the update to replace one or more blocks in the plurality of blocks.

10. A computing apparatus comprising:
a storage system;
a processing system operatively coupled to the storage system; and
program instructions stored on the storage system to provide a networking controller service that, when executed by the processing system, direct the processing system to:
in response to reestablishing a connection with a computing element, obtain hashes that correspond to a hash tree generated from software defined networking configuration data received by the computing element during at least one previous connection with the networking service;
compare the hashes to expected hashes for the computing element;
determine that at least a portion of the software defined networking configuration data on the computing element requires an update based on the comparison; and
communicate the update for at least the portion of the software defined networking configuration to the computing element.

11. The computing apparatus of claim 10, wherein the hash tree comprises a Merkle tree.

12. The computing apparatus of claim 10, wherein the program instructions further direct the processing system to generate the expected hashes for the computing element using a current version of the software defined networking configuration data.

13. The computing apparatus of claim 10, wherein the software defined networking configuration data comprises a plurality of blocks, and wherein the portion of the software defined networking configuration comprises one or more blocks in the plurality of blocks.

14. The computing apparatus of claim 13, wherein a lowest level of the hash tree comprises a plurality of hashes generated from the plurality of blocks.

15. The computing apparatus of claim 13, wherein each block in the plurality of blocks comprises configuration data entries corresponding to logical networking elements, and wherein configuration data entries for dependent logical networking elements are grouped together in one or more common blocks of the plurality of blocks.

16. The computing apparatus of claim 10, wherein the software defined networking configuration data comprises a plurality of blocks, wherein a first subset of the plurality of blocks correspond to data to configure logical networking elements for one or more software defined networks, and wherein a second subset of the plurality of blocks correspond to sparse blocks of data.

17. The computing apparatus of claim 16, wherein the program instructions further direct the processing system to identify the first subset of the plurality of blocks based on logical networking elements on the computing element.

18. The computing apparatus of claim 16, wherein communicating the update for at least the portion of the software defined networking configuration to the computing element comprises communicating the update to replace one or more blocks in the plurality of blocks.

19. A method comprising:
obtaining software defined networking configuration data from a networking controller service, wherein the software defined networking configuration data comprises a plurality of blocks;
maintaining a hash tree based on the software defined networking configuration data;
in response to reestablishing a connection with the networking controller service, communicating the hash tree to the networking controller service;
obtaining one or more replacement blocks for the software defined networking configuration data; and
updating the hash tree based on the one or more replacement blocks.

20. The method of claim 19, wherein the hash tree comprises a Merkle tree.
